(19) United States
(12) Patent Application Publication
(10) Pub. No.: US 2020/0108745 A1
(43) Pub. Date: Apr. 9, 2020

(54) VEHICLE SEAT

(71) Applicant: TACHI-S ENGINEERING U.S.A., INCORPORATED, Farmington Hills, MI (US)

(72) Inventors: Takuya Hori, Farmington Hills, MI (US); Ronald Valerius, Farmington Hills, MI (US); Donald Land, Farmington Hills, MI (US); Wayne Eck, Farmington Hills, MI (US)

(21) Appl. No.: 16/154,783

(22) Filed: Oct. 9, 2018

(51) Int. Cl. B60N 2/30; B60N 2/20; B60N 2/58

(52) U.S. Cl. CPC B60N 2/3075; B60N 2/3011; B60N 2/5883; B60N 2/206

(57) ABSTRACT

A vehicle seat is provided with a plate member attached to the back of the seat back. The plate member is configured by a core plate and a cover that covers the core plate, the plate member is sewed together with a cover of the back of the seat back, and a sewed part of the cover of the plate member and the cover of the seat back functions as a turning axis of the plate member. The plate member is turned an unfolded state covering concave clearance formed between the back directed upward of the seat back and a floor surface on the back side by pushing down the seat back forward, and the plate member is turned a housed state in which the plate member is piled on the back of the seat back by raising the seat back backward.

### BACKGROUND

This disclosure relates to a vehicle seat, for example, this disclosure can be applied to a vehicle seat utilizing the back for loading space.

For the vehicle seat, the one having structure that a seat back is pushed down forward and the back of the seat back is utilized for loading space can be given (for example, JP-A No. 2013-116661).

### SUMMARY

Concave clearance is formed between the back directed upward and a floor surface on the back side (for example, a floor surface of cargo room) by pushing down the seat back forward.

An object of this disclosure is to provide a vehicle seat covering the concave clearance.

Another object and a new characteristic will be clarified from description of this disclosure and accompanied drawings.

Brief description of a summary of representatives in this disclosure is as follows.

That is, the vehicle seat is provided with a seat cushion, a seat back connected to the seat cushion and turnable in a longitudinal direction, and a plate member attached to the back of the seat back. The plate member is configured by a core plate and a cover that covers the core plate, the plate member is sewed together with a cover of the back of the seat back, and a sewed part of the cover of the plate member and the cover of the seat back functions as a turning axis of the plate member. The plate member is pushed on the back side by pushing down the seat back forward, the plate member is turned an unfolded state covering concave clearance formed between the back directed upward of the seat back and a floor surface on the back side, the plate member is raised forward by raising the seat back backward, and the plate member is turned a housed state in which the plate member is piled on the back of the seat back.

### BRIEF DESCRIPTION OF THE DRAWINGS

FIG. 1 is a side view showing the inside of a vehicle;

FIG. 2 is a back view showing a back row seat in FIG. 1;

FIG. 3 is a side view showing a state in which a seat back of the back row seat shown in FIG. 1 is being pushed down forward and viewed in a direction B from a position A in FIG. 2;

FIG. 4 is a side view showing a state in which the seat back of the back row seat shown in FIG. 1 is pushed down forward and viewed in the direction B from the position A in FIG. 2;

FIG. 5 is a top view showing the back row seat shown in FIG. 4;

FIG. 6 is a side view showing a state in which the seat back of the back row seat shown in FIG. 1 is started to be raised and viewed in the direction B from the position A in FIG. 2;

FIG. 7 is a side view showing a state in which the seat back of the back row seat shown in FIG. 1 is being raised and viewed in the direction B from the position A shown in FIG. 2; and

FIG. 8 is a sectional view showing a plate member shown in FIG. 1.

### DESCRIPTION OF THE PREFERRED EMBODIMENTS

An embodiment will be described referring the drawings below. However, the same reference numeral is allocated to the same component in the following description and its repeated description may be omitted. The drawings may be schematically expressed as to width, thickness and a configuration of each part, compared with an actual situation so as to more clarify description, however, to the end, the drawings are one example, and the drawings do not limit interpretation of the present invention.

The following description is based upon a case that a vehicle equipped with a vehicle seat is placed on a horizontal plane and a vertical direction is defined as a perpendicular direction. In addition, a longitudinal direction (FR, RR) is defined so that it coincides with a longitudinal direction of the vehicle and a lateral direction (a direction of width) is defined so that it coincides with a direction of the width of the vehicle. FR denotes a forward direction of the vehicle and RR denotes a backward direction of the vehicle. Moreover, the right side and the left side respectively viewed from the back of the vehicle of the vehicle seat are called RH and LH in the following description.

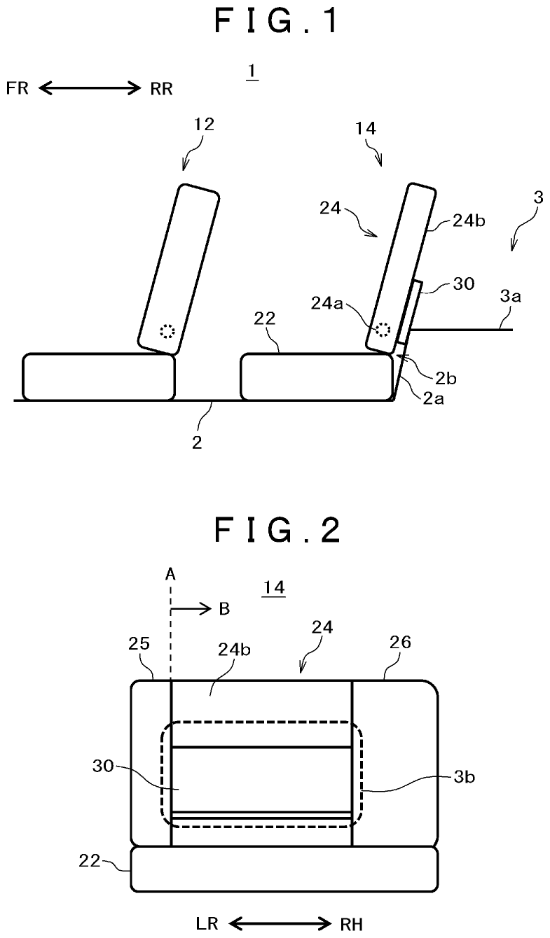

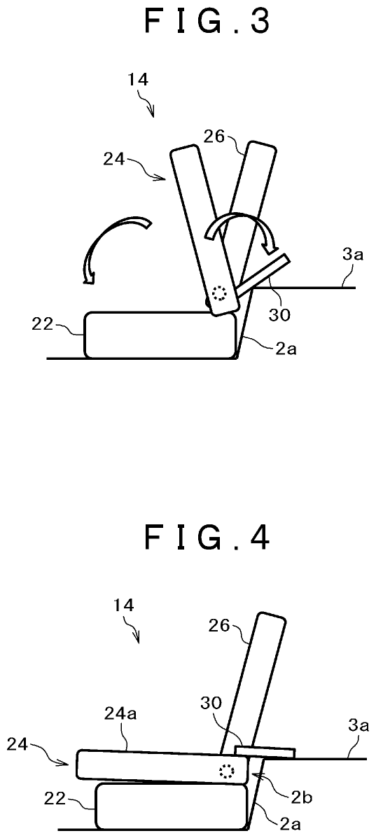

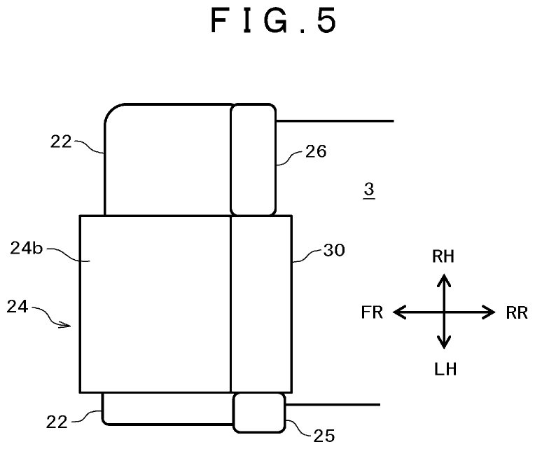

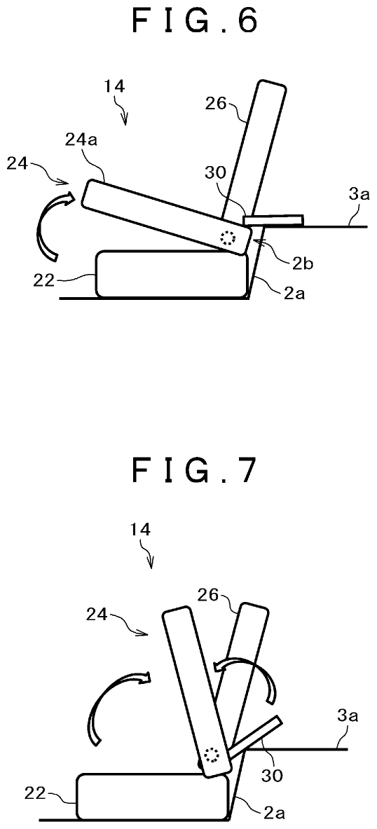

First, referring to FIGS. 1 to 5, a configuration of the vehicle seat in an embodiment will be described. FIG. 1 is a side view showing the inside of the vehicle. FIG. 2 is a back view showing a back row seat shown in FIG. 1. FIG. 3 is a side view showing a state in which a seat back of the back row seat is being pushed down forward and viewed in a direction B from a position A in FIG. 2. FIG. 4 is a side view showing a state in which the seat back of the back row seat shown in FIG. 1 is pushed down forward and viewed in the direction B from the position A in FIG. 2. FIG. 5 is a top view showing the back row seat shown in FIG. 4. FIG. 6 is a side view showing a state in which the seat back of the back row seat shown in FIG. 1 is started to be raised and viewed in the direction B from the position A in FIG. 2. FIG. 7 is a side view showing a state in which the seat back of the back row seat shown in FIG. 1 is being raised and viewed in the direction B from the position A in FIG. 2.

As shown in FIG. 1, a front row seat 12 and the back row seat 14 are arranged on a floor 2 of the vehicle 1 in order from the front toward the back. A level difference part 2a turned higher toward the back is formed at the back of an area in which the back row seat 14 is arranged and at the back of the level difference part, a floor 3a of cargo room 3 is formed. Clearance 2b is formed between the back row seat 14 and the level difference part 2a. The cargo room 3 is independent from passenger space in a sedan, a coupe and others. The cargo room 3 may be also provided in the same room as passenger space in a one box car, a mini-van and others.

As shown in FIGS. 1, 2, the back row seat 14 being a vehicle seat is provided with a seat cushion 22 to be seating of a passenger and seat backs 24, 25, 26 connected to the seat cushion 22 and to be a backrest. The seat back 24 can be turned forward around a turning shaft 24a in a lower part by releasing a locking device not shown. A plate member 30 turnable on the back side is attached to the back of the seat back 24. The seat backs 25, 26 are fixed not to turn forward. The seat backs 24, 25 can be seated by two passengers, the seat back 26 can be seated by one passenger, and the seat back 24 is made wider than the seat back 26. A wall (not shown) between the passenger space and the cargo room 3 has an opening 3b.

The seat cushion 22 includes a seat cushion frame, a urethane pad and a cover. The seat backs 24, 26 also have the similar configuration and are configured by a urethane pad fixed to the seat back frame and wrapped by a cover 24b.

The plate member 30 is in the shape of a flat plate having the similar lateral width to lateral width of the seat back 24 as shown in FIG. 2. One end of the plate member 30 is sewed together with the cover 24b on the back side of the seat back 24 and the other end is released.

A configuration and size of the plate member 30 are formed in accordance with vehicle structure such as the level difference part 2a, the wall or its opening 3b. In a state in which the seat back 24 stands, the plate member 30 is fixed by the level difference part 2a to prevent the seat back from being pushed down backward. In other words, in the state in which the seat back 24 stands, a part of the plate member 30 is held between the seat back 24 and the level difference part 2a. As shown in FIG. 3, when the seat back 24 is turned forward, the plate member 30 is guided by the level difference part 2a and the floor 3a and is gradually turned backward.

The back row seat 14 has a configuration that the seat back 24 is pushed down forward and its back can be turned at an approximately same level as a top face of the floor 3a as shown in FIGS. 4, 5. In addition, the back row seat 14 can cover the clearance 2b because the concave clearance 2b formed between the back of the seat back 24 and the top face of the floor 3a is covered when the seat back 24 is pushed down forward.

As shown in FIGS. 6, 7, when the seat back 24 is raised backward, the plate member 30 is guided by the level difference part 2a and the floor 3a and is raised on the front side.

Hereby, the plate member has a foldable/unfoldable configuration that as shown in FIG. 1, the plate member 30 is piled on the back of the seat back 24 by raising the plate member on the front side, is compactly housed and as shown in FIGS. 4, 5, the plate member is unfolded with the plate member covering the clearance 2b by pushing down it on the back side. The plate member 30 is hit on the floor 3a in its unfolded condition and is turned a state in which the plate member can bear a load from the upside. In addition, the plate member 30 can be automatically moved by pushing down or raising the seat back 24.

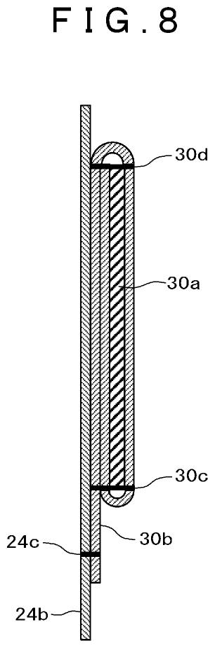

Next, the details of the plate member 30 will be described referring to FIG. 8. FIG. 8 is a sectional view showing the plate member shown in FIG. 1.

As shown in FIG. 8, the plate member 30 is formed by wrapping and sewing a plastic plate 30a being a core plate in a cover 30b made by the same material as the cover 24b on the back side of the seat back 24. Seams 30c, 30d which are sewed parts are extended in the lateral direction of the vehicle. The plastic plate 30a is rectangular in a plan view and is formed by polypropylene (PP) in a manner that the plastic plate has thickness of 1.5 mm for example. The cover 30b is a carpet NPP200 for example. The material of the carpet may be also tricot. The plate member 30 is attached to the cover 24b by sewing the plate member 30 and the cover 24b on the back side of the seat back 24. Seams 24c being a sewed part are extended in the lateral direction of the vehicle.

In FIG. 3, the seat back 24 is in an upright state. The seams 24c are located on the lower end side of the seat back 24, the seams 30c are located on the lower end (the one end) side of the plastic plate 30a, and the seams 30d are located on the upper end (the other end) side of the plastic plate 30a. In the state that the seat back 24 is upright, the seams being a turning axis of the plate member 30 are set in a lower position than the turning shaft 24a of the seat back 24. In addition, in a state in which the seat back 24 is tilted forwardest, the seams 24c being the turning axis of the plate member 30 are set in a higher position than the floor 3a.

Thickness of the plate member 30 in the vicinity of the seams 24c is equivalent to thickness of the cover 30b and the thickness of the plate member between the seams 30c to the seams 30d is equivalent to the whole thickness of one layer of the plastic plate 30a and three layers of covers 30b. The plate member 30 is pushed down backward using the seams 24c for the turning axis, however, as the plate member in the vicinity of the seams 24c is thin, turning is easily performed. In addition, in a state in which the seat back 24 is pushed down forward, the vicinity of the seams 30c is located on the back side of the seat back 24, the vicinity of the seams 30d is located on the side of the floor 3a, a top face of the plate member 30 is protruded from the back of the seat back 24 and the top face of the floor 3a by the thickness of the plate member 30, however, as no hinge bracket is used, a large flat surface formed by the back of the seat back 24, the plate member 30 and the floor 3a can be utilized for a cargo room surface without providing a recess on the back of the seat back 24 and the floor 3a.

The present invention made by these inventors has been described in the concrete on the basis of the embodiment, however, the present invention is not limited to the above-mentioned embodiment, and it need scarcely be said that the present invention is variously variable.

For example, in the embodiment, the vehicle is provided with two rows of seats, however, the vehicle may be also provided with more rows of seats than two rows of seats. In this case, the back row seat in the embodiment is applied to the backmost seat.

Moreover, in the embodiment, the seat back of the back row seat is divided in two; however, the back row seat may be also configured by one seat back.

1. A vehicle seat, comprising:
a seat cushion;
a seat back connected to the seat cushion and turnable in a longitudinal direction; and
a plate member attached to the back of the seat back,
wherein the plate member is configured by a core plate and a cover that covers the core plate and is sewed together with a cover of the back of the seat back;
a sewed part of the cover of the plate member and the cover of the seat back functions as a turning axis of the plate member;
the plate member is pushed down on the back side by pushing down the seat back forward and is turned in an unfolded state in which the plate member covers concave clearance formed between the back directed upward of the seat back and a floor surface on the back side; and
the plate member is configured in a manner that the plate member is raised forward by raising the seat back backward and the plate member is turned in a housed state in which the plate member is piled on the back of the seat back.

2. The vehicle seat according to claim 1,
wherein the plate member is provided with a second sewed part located between the sewed part and one end of the core plate and a third sewed part located on the reverse side to the second sewed part at the other end of the core plate; and
the cover is configured by three layers in the second sewed part and the third sewed part.

3. The vehicle seat according to claim 2,
wherein in a state in which the seat back is upright, the sewed part is located between the core plate and a lower end of the seat back.

4. The vehicle seat according to claim 3,
wherein the core plate is a plastic plate; and
the cover of the plate member and the cover of the seat back are made of the same material.

5. The vehicle seat according to claim 1,
wherein the plate member is held between the seat back and a level difference part of a vehicle in the housed state.
